(19) United States
(12) Patent Application Publication
(10) Pub. No.: US 2018/0348004 A1
(43) Pub. Date: Dec. 6, 2018

(54) LIGHT GUIDANCE SYSTEM FOR PROCESSING SELF-SERVICE ORDERS AT KIOSK STATIONS

(71) Applicant: Walmart Apollo, LLC, Bentonville, AR (US)

(72) Inventors: Theresa Mosier, Springdale, AR (US); Bridget Leffler, Bentonville, AR (US); Luz Rivera, Rogers, AR (US); Rebecca Engelke, Rocky Comfort, MO (US); Behzad Nemati, Springdale, AR (US); Wayne Marshall, Bentonville, AR (US); Yurgis Mauro Bacallao, Centerton, AR (US)

(21) Appl. No.: 15/991,171

(22) Filed: May 29, 2018

Related U.S. Application Data
(60) Provisional application No. 62/515,749, filed on Jun. 6, 2017.

(51) Int. Cl. G01C 21/36; G07F 9/02; G06F 3/0488

(52) U.S. Cl. CPC G01C 21/3626; G06F 3/0488; G07F 9/023; G01C 21/3605

(57) ABSTRACT

A guidance system and method including receiving self-service option information from a self-service kiosk, wherein the self-service kiosk prompts the user to input information regarding a self-service option, processing the self-service option information to determine a correct kiosk destination for the user from a plurality of kiosk destinations, wherein the self-service order is processed at the correct kiosk destination, actuating a light source to illuminate a pathway to be followed by the user to reach the correct kiosk destination, wherein the pathway is visible on a floor of a user queuing location for processing self-service orders, between the self-service kiosk and the correct kiosk destination located in the user queuing location for processing self-service orders of the retail location, and prompting an available self-service kiosk to alert a nearby customer to an availability of the available self-service kiosk, to reduce a queue of customers in the user queuing location.

### CROSS REFERENCE TO RELATED APPLICATION[S]

This application claims the benefit of U.S. Provisional application No. 62/515,749, filed Jun. 6, 2017, the contents of which are incorporated herein in their entirety.

### FIELD OF TECHNOLOGY

The present invention relates to a light guidance system, and more specifically to embodiments of a light guidance system for reducing a user queue in a user queuing location in a retail store.

### BACKGROUND

Areas designated for customer return and item pickup at a retail store can at times be occupied by many customers, which increases a wait time for customers.

### SUMMARY

An embodiment of the present invention relates to a method, and associated computer system and computer program product, for processing self-service orders in a retail location, comprising: receiving, by a processor of a computing system, self-service option information from a self-service kiosk, the self-service kiosk having at least one sensor to detect a presence of a user, wherein the self-service kiosk prompts the user to input information regarding a self-service option, in response to the detection of the user; processing, by the computing system, the self-service option information to determine a correct kiosk destination for the user from a plurality of kiosk destinations, based on the self-service option input by the user and received from the self-service kiosk, wherein the self-service order is processed at the correct kiosk destination; actuating, by the processor, a light source to illuminate a pathway to be followed by the user to reach the correct kiosk destination, wherein the pathway is visible on a floor of a user queuing location for processing self-service orders, between the self-service kiosk and the correct kiosk destination located in the user queuing location for processing self-service orders of the retail location; and prompting, by the processor, an available self-service kiosk to audibly or visually alert a nearby customer to an availability of the available self-service kiosk, to reduce a queue of customers in the user queuing location.

Another embodiment of the present invention relates to a method comprising receiving, by a processor of a computing system, self-service option information at a self-service kiosk in the retail location, the self-service kiosk having at least one sensor coupled to the processor to detect a presence of a user nearby the self-serving kiosk, wherein the self-service kiosk prompts the user to input information into a graphical user interface of the self-service kiosk regarding a self-service option, in response to the detection of the user, analyzing, by the computing system, the self-service option information to determine a correct kiosk destination for the user from a plurality of kiosk destinations, based on the self-service option input by the user and received from the self-service kiosk, wherein the self-service order is processed at the correct kiosk destination, activating, by the processor, at least one lighting element to illuminate the guided pathway to be followed by the user to reach the correct kiosk destination, wherein the guided pathway is visible on a floor of a user queuing location for processing self-service orders, between the self-service kiosk and the correct kiosk destination located in the user queuing location for processing self-service orders of the retail location, and prompting, by the processor, an available self-service kiosk to audibly or visually alert a nearby customer to an availability of the available self-service kiosk, to reduce a queue of customers in the user queuing location

### BRIEF DESCRIPTION OF THE DRAWINGS

FIG. 1 depicts a block diagram of a guidance system, in accordance with embodiments of the present invention.

FIG. 2 depicts a user queue location having a starting kiosk and a plurality of destination kiosks, in accordance with embodiments of the present invention.

FIG. 3A depicts a first illuminated pathway to a correct destination kiosk, in accordance with embodiments of the present invention.

FIG. 3B depicts a second illuminated pathway to a correct destination kiosk, in accordance with embodiments of the present invention.

FIG. 3C depicts a third illuminated pathway to a correct destination kiosk, in accordance with embodiments of the present invention.

FIG. 4 depicts a flow chart of a method for processing self-service orders in a user queue location at a retail store, in accordance with embodiments of the present invention.

FIG. 5 depicts a block diagram of a computer system for the guidance system of FIG. 1, capable of implementing methods for processing self-service orders of FIG. 4, in accordance with embodiments of the present invention.

### DETAILED DESCRIPTION

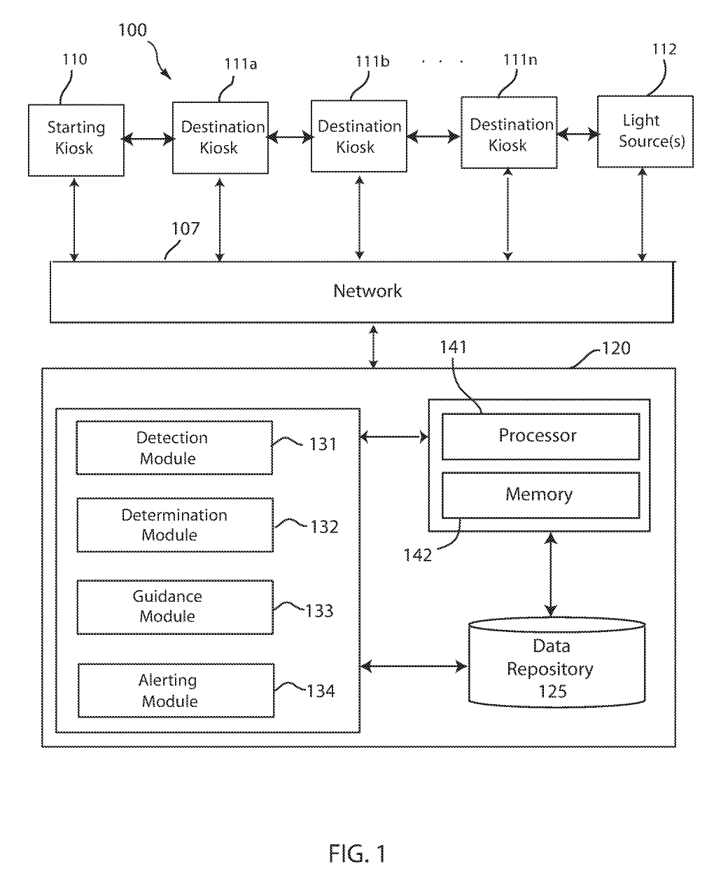

Referring to the drawings, FIG. 1 depicts a block diagram of a guidance system, in accordance with embodiments of the present invention. Embodiments of a guidance system 100 may guide users to a correct kiosk destination based on the user's needs, with little or no store representative interaction. For instance, embodiments of the guidance system 100 may first detect a presence of a user at a starting kiosk, and prompt the user to enter information used to determine which destination kiosk the user should visit to accomplish the user's goal (e.g. returning an item, picking up an item purchased online, etc.) In response to determining the correct destination kiosk, the guidance system 100 may illuminate a pathway to the correct destination kiosk for the user to follow to avoid confusion and assist the user in reaching the destination kiosk. Further, the guidance system 100 may use one or more sensors or starting kiosks to detect available starting kiosks and alert or otherwise entice a user in a user queuing location to approach the starting kiosk, which can help maintain a continuous flow of users and reduce a queue of users in a user queue location at a retail store.

Embodiments of the guidance system 100 may include a computing system 120. Embodiments of the computing system 120 may be one or more servers or remote computing systems communicatively coupled to the starting kiosk 110, the plurality of destination kiosks 111a, 111b . . . 111n, and one or more light sources 112, wherein the computing system 120 services requests and performs the functions of the guidance system 100. In other embodiments, the computing system 120 may be an onboard computing system of the starting kiosk 110, wherein information input via a graphical user interface of the starting kiosk 110 may be transmitted to the onboard computing system 120, without having to transmit information over a wireless network.

Embodiment of guidance assistance system 100 may comprise one or starting kiosks 110 communicatively coupled to a computing system 120 over a network 107. The number of starting kiosks 110 connecting to computer system 120 over network 107 may vary from embodiment to embodiment, depending on a size of a user queuing location, a number of users visiting the retail store, the number of orders processed, and the like. Embodiments of a starting kiosk 110 may be a kiosk, a self-service kiosk, a computer terminal, a computer, an initial kiosk, a user interactive computing device, and the like. The starting kiosk 110 may be a starting point or entry point for users prior to being guided to a correct destination. Embodiments of the starting kiosk 110 may include a housing or a standing structure for placement on a floor of a retail store in a user queue location. Embodiments of the starting kiosk 110 may include a computer processor for carrying out various tasks associated with the starting kiosk, such as transmitting data/information to the computing system 120 via a network controller and/or transmitter. Moreover, embodiments of the starting kiosk 110 may include a display for interacting with the user via a graphical user interface. Various sensors may be operably coupled to the starting kiosk 110 for detecting a presence of a user. Lighting devices, speakers, and other alerting devices may be operably coupled to the starting kiosk 110 for communicating an availability to users in the user queue location.

As shown in FIG. 1, the starting kiosk 110 may transmit data about one or more orders, items of the user, the user's intention and purpose for visiting the user queue location, etc. (e.g. “user order data”) received from the starting kiosk 110 by connecting to computing system 120 over the network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120, starting kiosk 110, plurality of destination kiosks 111a, 111b . . . 111n, and light source(s) 112, a connection to one or more network accessible knowledge bases containing information of one or more users, network repositories or other systems connected to the network 107 that may be considered nodes of the network 107. In some embodiments, where the computing system 120 or network repositories allocate resources to be used by the other nodes of the network 107, the computer system 120 and network repository may be referred to as servers.

The network repository may be a data collection area on the network 107 which may back up and save all the data transmitted back and forth between the nodes of the network 107. For example, the network repository may be a data center saving and cataloging user order data sent by the one or more starting kiosks 110 to generate both historical and predictive reports regarding a particular user store item. In some embodiments, a data collection center housing the network repository may include an analytic module capable of analyzing each piece of data being stored by the network repository. Further, the computer system 120 may be integrated with or as a part of the data collection center housing the network repository. In some alternative embodiments, the network repository may be a local repository (not shown) that is connected to the computer system 120.

Embodiment of guidance system 100 may also comprise one or more destination kiosks 111a, 111b . . . 111n (referred to collectively as “destination kiosks 111”) communicatively coupled to a computing system 120 over a network 107. The number of destination kiosks 111 connecting to computer system 120 over network 107 may vary from embodiment to embodiment, depending on the number of service options provided by the retail location. The reference numbers with sub-letters and/or ellipses, for example describing destination kiosks as 111a, 111b . . . 111n may signify that the embodiments are not limited only to the amount of elements actually shown in the drawings, but rather, the ellipses between the letters and the n^{th} element indicate a variable number of similar elements of a similar type. For instance, with regard to the destination kiosks 111 depicted in FIG. 1, any number of a plurality of destination kiosks may be present including destination kiosk 111a, destination kiosk 111b, and a plurality of additional destination kiosks up to the n^{th} number, wherein the variable “n” may represent the last element in a sequence of similar elements shown in the drawing.

Embodiments of a destination kiosk 111 may be a kiosk, a self-service kiosk, a computer terminal, a computer, a user interactive computing device, and the like. The destination kiosk 111 may be a kiosk location for completing a user's request or transaction, to which the starting kiosk 110 has guided the user. Embodiments of the destination kiosk 111 may include a housing or a standing structure for placement on a floor of a retail store in a user queue location. Embodiments of the destination kiosk 111 may include a computer processor for carrying out various tasks associated with the destination kiosk 111, such as transmitting data/information to the computing system 120 via a network controller and/or transmitter. Moreover, embodiments of the destination kiosk 111 may include a display for interacting with the user via a graphical user interface. Various sensors may be operably coupled to the destination kiosk 111 for assisting detection by the user as the user follows the illuminated pathway to the correct destination kiosk 111. Lighting devices, speakers, and other alerting devices may be operably coupled to the destination kiosk 111 for communicating an availability to users in the user queue location. In some embodiments, the destination kiosk 111 may be operated or otherwise supervised by a store representative.

As shown in FIG. 1, a number of destination kiosks 111 may transmit data about the user, the order, store items, the transaction (e.g. “user transaction data”) received from the user inputting information or received by scanning information or other unique identifiers by connecting to computing system 120 over the network 107.

Referring still to FIG. 1, embodiments of the computing system 120 may include a detection module 131, a determination module 132, a guidance module 133, and an alerting module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the detection module 131 may include one or more components of hardware and/or software program code for detecting a presence of a user at a starting kiosk 110. For instance, the starting kiosk 110 may include a sensor, such as one or more cameras, that may capture video proximate or otherwise near the starting kiosk 110. Embodiments of the detection module 131 may analyze a video feed transmitted to the computing system 120 from the starting kiosk 110 to detect and/or confirm a presence of a user ready to interact with the starting kiosk 110. If a user is within a proximity to the starting kiosk 110 based on the analysis of the video feed, the detection module 131 may cause the starting kiosk 110 to audibly draw the user to the starting kiosk 110. For instance, the starting kiosk 110 may play an audio file that emits sound and has a meaning, such as “Welcome!” or other welcoming phrase. Further, embodiments of the detection module 131 may detect or otherwise confirm a presence of a user ready to start operating the starting kiosk 110 in response to receiving an input from the user via the graphical user interface of the starting kiosk 110. For instance, the detection module 131 may detect that the user has touched the screen of the starting kiosk 110.

Embodiments of the computing system 120 of the guidance system 100 may include a determination module 132. Embodiments of the determination module 132 may include one or more components of hardware and/or software program code for processing self-service option information obtained from the user to determine a correct kiosk destination for the user from a plurality of kiosk destinations 111, based on the self-service option input by the user and received from the starting kiosk 110. For instance, in response to detecting a presence and potentially an engagement of a user with the starting kiosk 110 by the detection module 131, embodiments of the detection module 132 may prompt the user to input information regarding a self-service option. The prompting may include asking one or more questions to the user regarding a purpose of the user's visit to retail store, for example, “Are you here to return a purchased item?”, “Picking up an online order in store?”, or “Would you like to speak with a store representative?”. The user may select one of a plurality of selectable options via the graphical user interface of the starting kiosk 110. In other embodiments, the determination module 132 may instruct the starting kiosk 110 to prompt the user to scan a bar code, a QR code, enter a code or other unique identifier, which may be associated with a transaction, a purchase order, a store item, and the like, to automatically acquire information. The user may launch a mobile application on the user's mobile device that may generate a computer readable code that contains order information. The computer readable code may be read by a scanning device mounted to or otherwise coupled to the starting kiosk 110. Based on the information retrieved by hardware components of the starting kiosk 110 and sent to the computing system 120, the determination module 132 may determine a reason for the customer's visit, which may be used to determine which destination kiosk 111 is appropriate or best suited for assisting the user. For example, if the user selects a selectable option such as “In-Store Store Pick-Up,” the determination module 132 may determine that the destination kiosk 111 associated with in-store pick up of items purchased online is the correct destination for the user. If the user selects a selectable option such as “Return an Item,” the determination module 132 may determine that the destination kiosk 111 associated with and/or programmed for facilitating a return of a purchased item is the correct destination for the user. Further, if the user selects a selectable option such as “Speak With Representative,” the determination module 132 may determine that the destination kiosk 111 operated or otherwise supervised by a store representative is the correct destination for the user. Various questions and/or selectable options may be presented to the user to determine a correct destination kiosk for processing the user's needs. Additionally, the number of different types of destination kiosks 111 may vary depending on size or area of a customer support department of a store location, and a number of the same type of destination kiosks 111 may also vary depending on a volume of customers using a particular type of destination kiosk 111.

In an exemplary embodiment, a destination kiosk 111 may be located within the customer service department area of the store for each selectable option displayed on the graphical user interface of the starting kiosk 110. In another exemplary embodiment, multiple selectable options available for selection by the customer can be grouped together within a same destination kiosk 111.

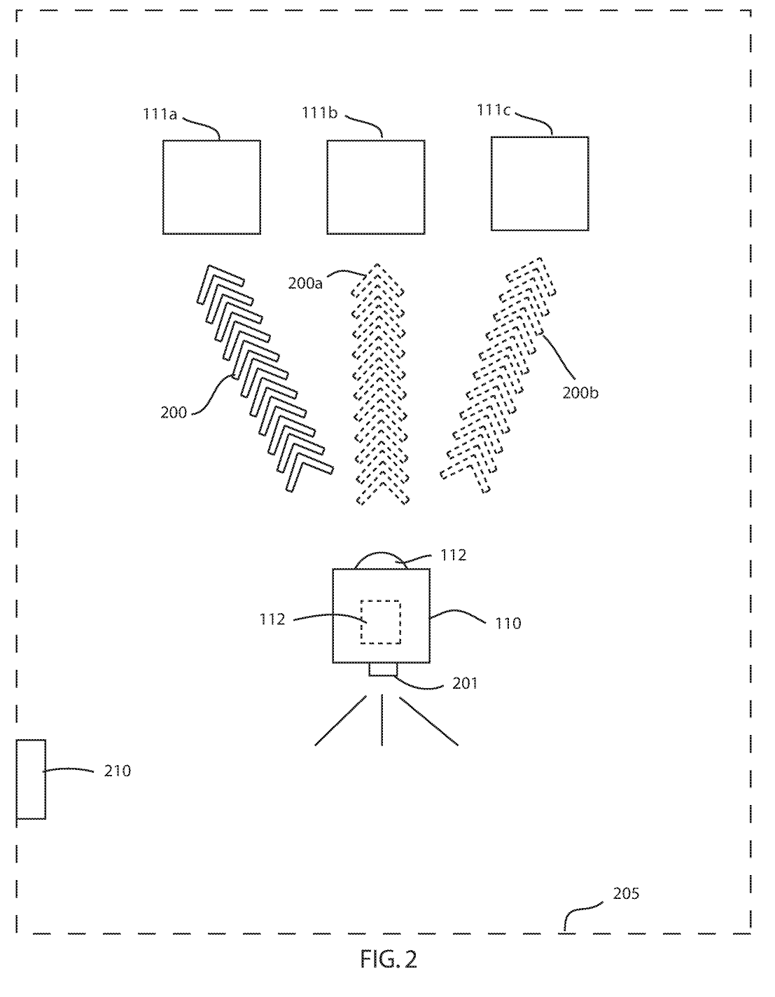

Referring still to FIG. 1, embodiments of the computing system 120 of the guidance system 100 may include a guidance module 133. Embodiments of the guidance module 133 may include one or more components of hardware and/or software program code for actuating a light source to illuminate a pathway to be followed by the user to reach the correct kiosk destination. For instance, embodiments of the guidance module 133 may actuate or otherwise cause one or more light sources to project or emit light into the physical environment of the retail store location, wherein an illuminated pathway is visible on a floor of a user queuing location for processing self-service orders, between the starting kiosk 110 and the correct kiosk destination 111 located in the user queuing location for processing self-service orders of the retail location. FIG. 2 depicts a user queue location 205 having a starting kiosk 110 and a plurality of destination kiosks 111, in accordance with embodiments of the present invention. Embodiments of a user queuing location 205 may be a physical real-world environment designated for customers to process self-service orders or other user orders, requests, transaction, etc. in a retail store location. The perimeter broken lines illustrated in FIG. 2 depict a boundary or perimeter of the user queuing location 205, which encompasses at least one starting kiosk 110 and a plurality of destination kiosks 111. Embodiments of the user queuing location 205 may vary in size/area, and may comprise a section of the retail store location, for example, proximate an entrance of the retail store or proximate a receiving area storing inventory for the retail location.

The starting kiosk(s) 110 may be positioned on a floor of the user queuing location 205 a distance from the destination kiosks 111, such that the user may be required to traverse at least some distance across the floor of the user queuing location 205 to reach a correct kiosk destination 111, as determined by the determination module 132. The destination kiosks 111 could be visible from the starting kiosk 110, or may be out-of-sight from the starting kiosk 110. To assist and/or guide the user to the correct destination kiosk 111, the guidance module 133 may activate or actuate one or more light sources 112 to illuminate a pathway to the correct destination kiosk 111. Embodiments of the light source 112 may be positioned within the environment of the user queuing location. In one embodiment, the light source 112 may be positioned overhead the starting kiosk 110 and the destination kiosks 111 (e.g. on a ceiling rafter, truss element, etc.), wherein light (e.g. laser, holographic images) is projected onto the floor of the user queuing location 205 to form an illuminated pathway 200 to destination kiosk 111a. In another embodiment, the light source 112 may be coupled to the starting kiosk 110, wherein light (e.g. laser) is projected onto the floor of the user queuing location 205 to form an illuminated pathway 200 to destination kiosk 111a. In other embodiments, light sources 112 may be coupled to the destination kiosks 111, wherein a command signal to activate may be sent from the computing system 120. In further embodiments, light sources 112 may be positioned on both the starting kiosk 110 and the destination kiosk 111. Embodiments of the light source 112 may be laser array, having multiple light sources. A support structure of the laser array may be fastened to a structural member of a ceiling or wall of the user queuing location 205 to position the light sources above the floor of the user-queuing location 205. Depending on a distance between the destination kiosk 111 and starting kiosk 110, multiple independent light sources 112, such as an array attached to the ceiling, may be needed to cover the distance. If a wall or other divider is located between the destination kiosk 111 and the starting kiosk 110, such that a line-of-sight of the laser/light from the light sources is blocked after a certain distance, a second or additional light sources 112 may be needed to ensure completion of the illuminated pathway. The command or signal sent to the laser array may be transmitted over a wired connection or wireless connection to the laser array, or light source 112. The light source 112 may have a wireless network interface capable of connecting to the starting kiosk 110 over network 7. Other communication links may be used to send commands to the light source 112 for actuating the light source 112.

The light may be projected in various patterns, such as rows, a continuous line, a plurality of chevrons, arrows, and the like. Pathways 200a, 200b are shown in broken lines to indicate that the pathways between the starting kiosk 110 and the destination kiosks 111b, 111c, respectively, may also be formed by light from the light source 112, but not while the pathway 200 is also illuminated, for example. For instance, if the determination module 132 determines that the destination kiosk 111b is the correct or best suited kiosk for the user's needs, pathway 200a may be illuminated by the light source 112, while light may not be projected onto the floor to form pathways 200, 200b, and if the determination module 132 determines that the destination kiosk 111c is the correct or best suited kiosk for the user's needs, pathway 200b may be illuminated by the light source 112, while light may not be projected onto the floor to form pathways 200, 200a.

Accordingly, the guidance module 133 may cause the light source 112 to project or otherwise emit light onto the floor in a pattern to form a pathway between the starting kiosk 110 to a single correct destination kiosk 111, which may be followed by the user as the user moves across the user queuing location to the destination kiosk 111 determined to be the most appropriate or correct kiosk to satisfy the user's needs.

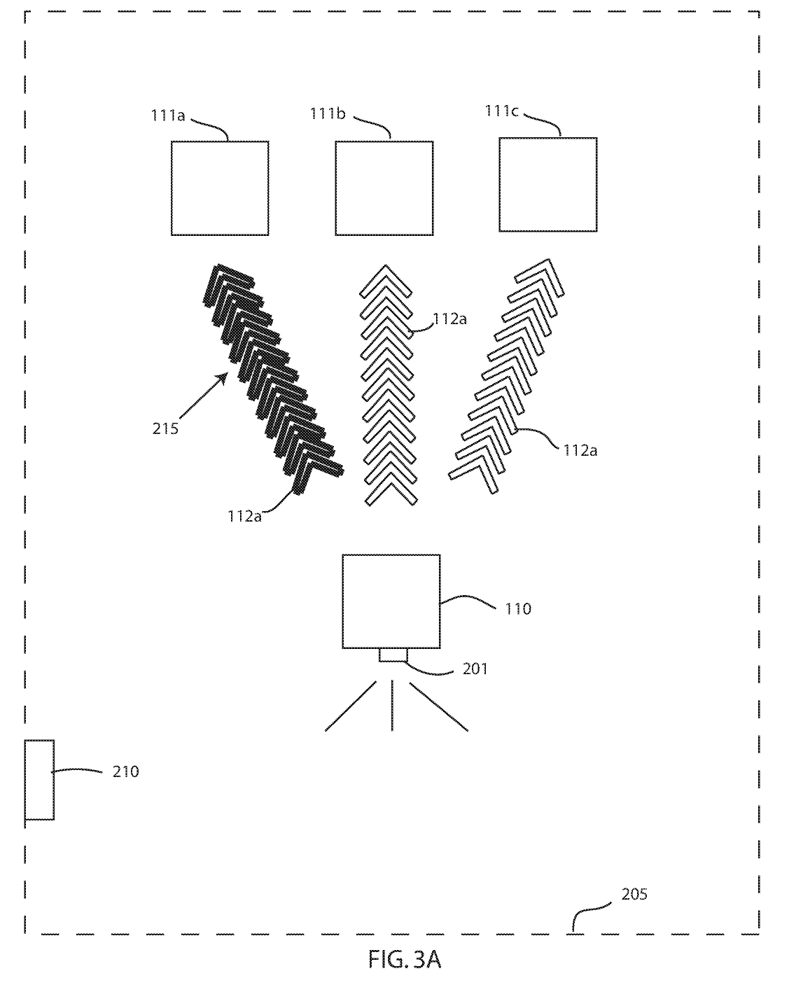

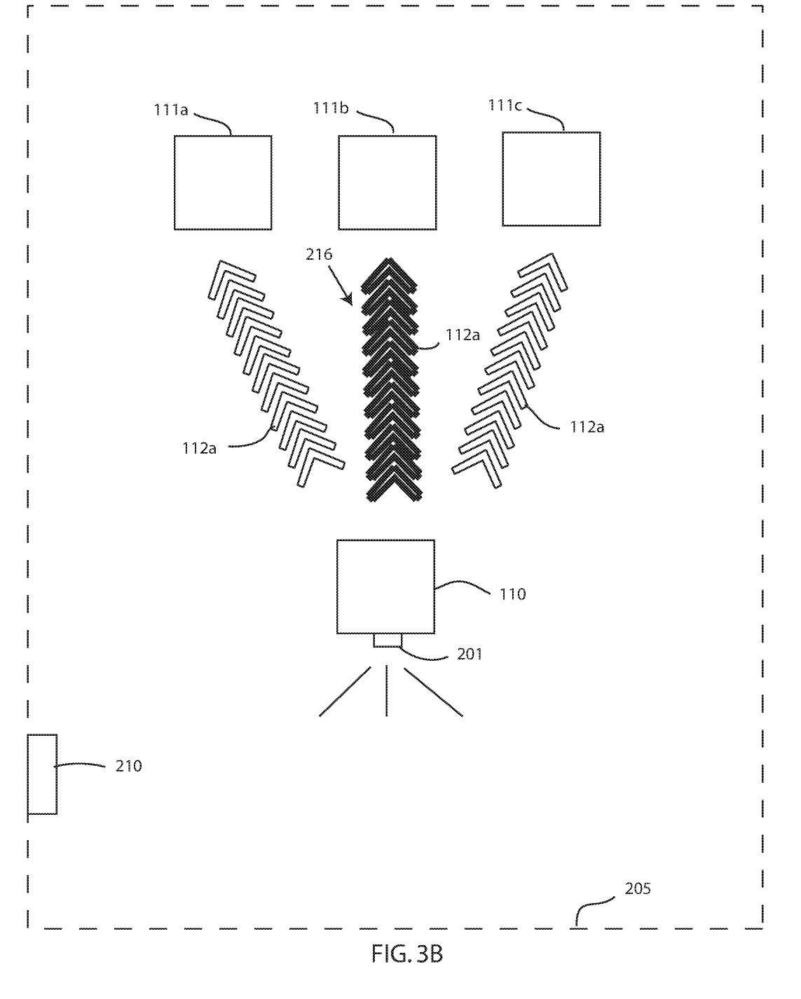

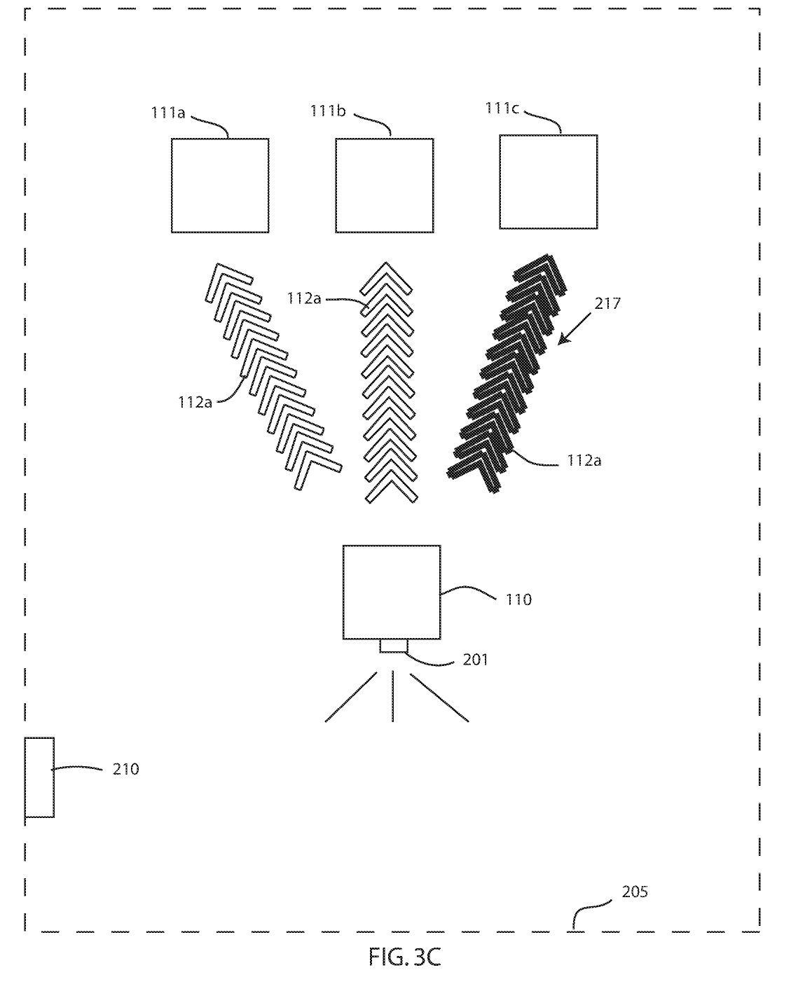

In other embodiments, the light source 112 may be a plurality of individual lighting sources disposed on the floor of the user queuing location 205. The individual lighting elements may be built into the floor or otherwise embedded into the floor of the user-queuing location 205. In instances where a path from the starting kiosk 110 to the destination kiosk 111 includes one or more turns (e.g. to go from one room to another room, or around a partition wall, etc.), the plurality of individual lighting elements can be designed to accommodate one or more turns. FIG. 3A depicts a first illuminated pathway 215 to a correct destination kiosk 111a, in accordance with embodiments of the present invention. The illuminated pathway 215 may be illuminated by a light source 112 comprising a plurality of individual lighting sources 112a. The individual lighting sources 112a may be arranged or otherwise disposed on the floor in a pattern that when taken together and activated may form an illuminated pathway 215 from the starting kiosk 110 to a destination kiosk 111. Embodiments of the lighting source 112a may be floor lighting, comprised of a plurality of LED lights placed, fastened, embedded, adhered, or otherwise attached to the floor. Embodiments of the lighting element 112a may include an integrated circuit with an embedded processor designed to carry out dedicated instructions received from the computing system. For instance, the lighting element 112a may receive a signal or command from the computing system 120 and activate a power source (e.g. battery) to deliver power to emit light (e.g. on/off position). The lighting element 112a may include a wireless network interface coupled to the embedded processor, which may receive and process the command signal from the computing system over network 7. In some embodiments, the lighting element 112a may include a dimming current switch to allow for light emitted from the lighting element 112a to be dimmed. In an exemplary embodiment, the lighting element 112a may receive power from a power line running underneath the floor, or may have a battery source. The lighting elements 112a may be interconnected, such that each lighting element 112a may communicate with adjacent lighting elements 112a. Furthermore, embodiments of the lighting elements 112a may be remote from the starting kiosk 110 and the destination kiosk 111, and may be installed such that the lighting elements 112a may be flush with the floor to reduce or eliminate a tripping hazard. The lighting elements 112a may be installed by specially designed floor tile that has one or more cutouts in a shape of the lighting element 112a, such that the lighting element 112a fits snugly within the cutout of the floor tile, flush with the floor surface. The lighting elements 112a may be replaceable by popping out or otherwise removing the lighting elements 112a from the floor.

In FIG. 3A, the individual lighting sources 112a are activated, actuated, or otherwise illuminated to form illuminated pathway 215 between the starting kiosk 110 and the destination kiosk 111a, while the light sources 112a defining a guided pathway between the other destination kiosks 111b, 111c may remain in an off position or in an on, but dimmer position. FIG. 3B depicts a second illuminated pathway 216 to a correct destination kiosk 111b, in accordance with embodiments of the present invention. In FIG. 3B, the individual lighting sources 112a are activated, actuated, or otherwise illuminated to form illuminated pathway 216 between the starting kiosk 110 and the destination kiosk 111b, while the light sources 112a associated with a pathway between the other destination kiosks 111a, 111c may remain in an off position or in an on, but dimmer position. FIG. 3C depicts a third illuminated pathway 217 to a correct destination kiosk 111c, in accordance with embodiments of the present invention. In FIG. 3C, the individual lighting sources 112a are activated, actuated, or otherwise illuminated to form illuminated pathway 217 between the starting kiosk 110 and the destination kiosk 111c, while the light sources 112a associated with a pathway between the other destination kiosks 111a, 111b may remain in an off position or in an on, but dimmer position.

Accordingly, the guidance module 133 may activate the individual lighting elements 112a to form a pathway between the starting kiosk 110 to a single correct destination kiosk 111, which may be followed by the user as the user moves across the user queuing location to the destination kiosk 111 determined to be the most appropriate or correct kiosk to satisfy the user's needs. The individual lighting elements 112a in a given pathway may be activated sequentially to create a moving light effect to further increase awareness of the user to the correct destination.

Referring back to FIG. 1, embodiments of the computing system 120 of the guidance system 100 may include an alerting module 134. Embodiments of the alerting module 134 may include one or more components of hardware and/or software program code for prompting an available self-service kiosk 110 to audibly and/or visually alert a nearby customer to an availability of the available self-service kiosk 110 to reduce a queue of customers in the user queuing location 205. For instance, embodiments of the alerting module 134 may actuate various sensors, lights, displays, etc. located on the starting kiosk 110 to attract an attention of a user in the user queuing location 205, drive awareness and/or change a queuing behavior of a user, when the starting kiosk 110 is not being used by a user, so that a time/duration of non-use of the starting kiosk 110 is reduced or limited. Reducing or limiting the duration of non-use of the starting kiosk 110 may be helpful in reducing a wait time for servicing users in the user queuing location, which may be accomplished by audibly and/or visually alerting users to the availability of the starting kiosk 110. The alerting module 134 may initiate or prompt one or more perceptible signals or communications to alert nearby users if the computing system 120 has yet to detect a presence of the user proximate or using the starting kiosk 110.

Further, a camera(s) 210 (as shown in FIGS. 2-3C) or other input mechanism coupled to the computing system 120 may capture information, data, video, images, sound, etc. (“environmental data”) in the environment that the starting kiosk 110 is also located. Embodiments of the alerting module 134 may analyze the environmental data to determine that users are nearby in the user queuing location 205 and may be assisted with the starting kiosk 110. Accordingly, embodiments of the alerting module 134 may initiate various sensory stimuli to attract or otherwise alert the users to the availability of the starting kiosk 110. In an exemplary embodiment, the alerting module 134 may instruct the display of the starting kiosk 110 to flash, lights 201 on the structure of the starting kiosk 110 to turn on and off, audio with a welcoming message to project from a speaker on the starting kiosk 110, and/or lighting elements located on a floor adjacent to the starting kiosk 110 to turn on and form a visible pathway to the starting kiosk 110. The light(s) 201 located on the starting kiosk 110 may be color coded to indicate availability, for example, if the light 201 is green, the kiosk 110 is available, and if the light 201 is red, the kiosk 110 is unavailable. Furthermore, additional sensors coupled to the computing system 120 and positioned within the user queuing environment may be used to collect additional information or provide information to assist a reduction of a user queue in a user queuing location 205. In an exemplary embodiment, a television or other display monitor may be positioned within the user queuing location 205 to provide information such as availability of starting kiosks 110, or how-to videos showing how the kiosks may be used.

Embodiments of the computing system 120 of the guidance system 100 may be equipped with a memory device 142 which may store the user data, transaction data, and/or user order data, and a processor 141 for implementing the tasks associated with the guidance system 100. Furthermore, various tasks and specific functions of the modules of the computing system 120 may be performed by additional modules, or may be combined into other module(s) to reduce the number of modules.

Various tasks and specific functions of the modules of the computing system 120 may be performed by additional modules, or may be combined into other module(s) to reduce the number of modules. Further, embodiments of the computer or computer system 120 may comprise specialized, non-generic hardware and circuitry (i.e., specialized discrete non-generic analog, digital, and logic-based circuitry) (independently or in combination) particularized for executing only methods of the present invention. The specialized discrete non-generic analog, digital, and logic-based circuitry may include proprietary specially designed components (e.g., a specialized integrated circuit, such as for example an Application Specific Integrated Circuit (ASIC), designed for only implementing methods of the present invention). Embodiments of the computing system 120 may be a dedicated computing system designed only to operate the starting kiosk 110 and the light sources. For example, embodiments of the computing system 120 may be located internal to a housing or structure of the starting kiosk 110 to control the user interface and take actions based on user selections input via the graphical user interface. Moreover, embodiments of the guidance system 100 controls remote, dedicated hardware devices (e.g. light sources 112, 112a) to physically alter a real-world environment, by emitting light across a floor to provide an illuminated pathway.

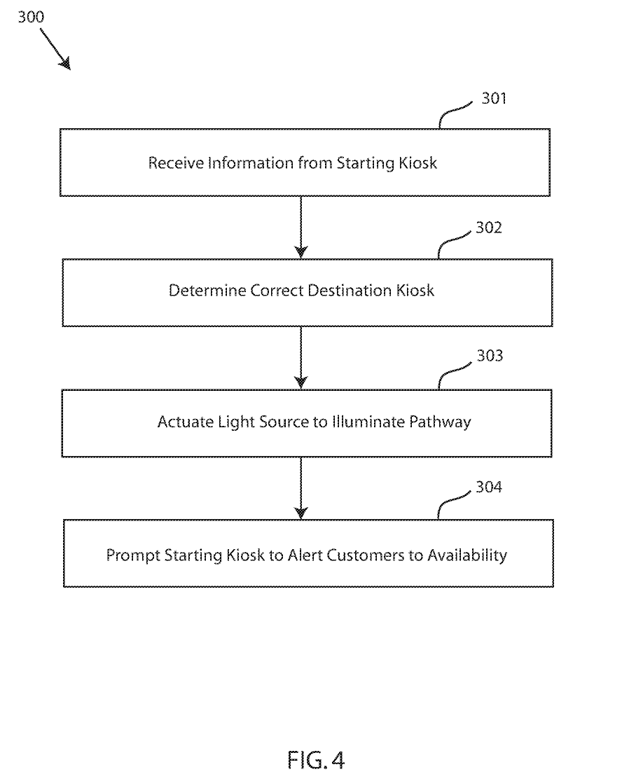

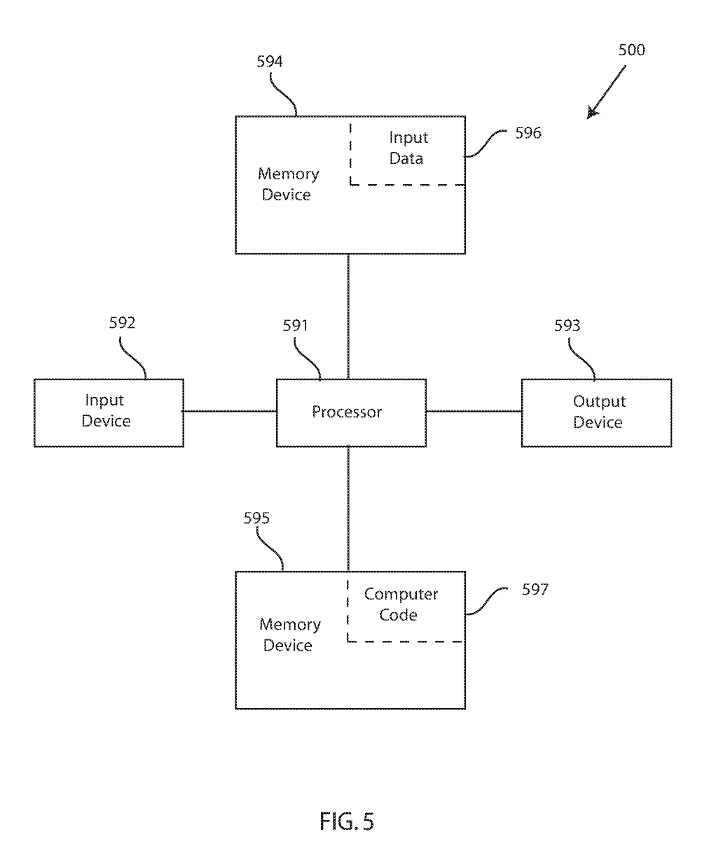

Referring now to FIG. 4, which depicts a flow chart of a method for processing self-service orders in a user queue location at a retail store, in accordance with embodiments of the present invention. One embodiment of a method 300 or algorithm that may be implemented for processing self-service orders in a user queue location at a retail store in accordance with the guidance system 100 described in FIG. 1 using one or more computer systems as defined generically in FIG. 5 below, and more specifically by the specific embodiments of FIG. 1.

Embodiments of the method 300 processing self-service orders in a user queue location at a retail store may begin at step 301 wherein information is received from starting kiosk 110. For example, a customer/user may input information or select options via GUI regarding an intended transaction within the user queuing location, which may be transmitted to the computing system 120. Received information may also be automatically acquired by scanners located at the kiosk 110. Step 302 determines a correct destination kiosk 111, based on the information received from the starting kiosk 110. A user may select an option for store item return, which may be used to determine that the correct or most appropriate destination kiosk is a self-service kiosk that specifically processes returns, which is located a distance from the starting kiosk 110. Alternatively, a user may select an option for in-store pickup of an item purchased online, which may be used to determine that the correct or most appropriate destination kiosk is a self-service kiosk that specifically processes in-store pickup requests, located a distance from the starting kiosk and at a location separate from the other destination kiosks.

Step 303 actuates a light source 112 to illuminate a pathway to the correct destination kiosk out of a plurality of destination kiosks 111. In response to the determining the correct destination, a pathway may be illuminated for the user to follow from the starting kiosk 110 to the destination kiosk 111 for processing the user's requests. The pathway may be illuminated by a light source located above the floor, such as an overhead laser projector or laser diode, which projects light in a pattern onto the floor. Alternatively, or in combination with the above-floor light source, the illuminated pathway may be comprised of floor lighting arranged in a pattern for the user to follow to the correct or final kiosk for processing the user's requests. As a user leaves the starting kiosk 110, step 304 prompts the starting kiosk 304 to alert nearby users to the availability of the starting kiosk 110 to reduce a duration of non-use of the starting kiosk 110. For example, the display of the starting kiosk 110 may flash to indicate availability, or various lights and sensors may create or effectuate a visual or audio stimulus to the users in the user queuing location to drive awareness that a starting kiosk 110 is available for use. Reducing the duration of non-use of the starting kiosk 110 may be helpful in reducing a user queue in the user queuing location.

FIG. 5 depicts a block diagram of a computer system for the guidance system of FIG. 1, capable of implementing methods for processing self-service orders of FIG. 4, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method processing self-service orders in a user queue location at a retail store, in the manner prescribed by the embodiments of FIG. 4 using the guidance system of FIG. 1, wherein the instructions of the computer code 597 may be executed by processor 591 via memory device 595. The computer code 597 may include software or program instructions that may implement one or more algorithms for implementing the methods of processing self-service orders in a user queue location at a retail store, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 5.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the sensors 110. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to guidance systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to process self-service orders. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method of processing self-service orders in a user queue location at a retail store. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for processing self-service orders in a user queue location at a retail store.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for activating light source hardware to illuminate a guided pathway to a correct kiosk destination that processes self-service orders in a retail location, comprising:
receiving, by a processor of a computing system, self-service option information at a self-service kiosk in the retail location, the self-service kiosk having at least one sensor coupled to the processor to detect a presence of a user nearby the self-serving kiosk, wherein the self-service kiosk prompts the user to input information into a graphical user interface of the self-service kiosk regarding a self-service option, in response to the detection of the user;
analyzing, by the computing system, the self-service option information to determine a correct kiosk destination for the user from a plurality of kiosk destinations, based on the self-service option input by the user and received from the self-service kiosk, wherein the self-service order is processed at the correct kiosk destination;
activating, by the processor, at least one lighting element to illuminate the guided pathway to be followed by the user to reach the correct kiosk destination, wherein the guided pathway is visible on a floor of a user queuing location for processing self-service orders, between the self-service kiosk and the correct kiosk destination located in the user queuing location for processing self-service orders of the retail location; and
prompting, by the processor, an available self-service kiosk to audibly or visually alert a nearby customer to an availability of the available self-service kiosk, to reduce a queue of customers in the user queuing location.

2. The method of claim 1, wherein the activating includes sending, by the processor, a command signal over a network to the at least one lighting element, in response to determining the correct kiosk destination out of the plurality of kiosk destinations.

3. The method of claim 1, wherein the at least one lighting element is located proximate a ceiling or elevated position with respect to the user, to project the pathway on the floor.

4. The method of claim 1, wherein the at least one lighting element is a plurality of light elements embedded in the floor of the user queuing location.

5. The method of claim 1, wherein the available self-service kiosk visually alerts the nearby customer to the availability by flashing a display of the available kiosk.

6. The method of claim 1, wherein the available self-service kiosk visually alerts the nearby customer to the availability by activating a light indicator on a front or sides of the available self-service kiosk.

7. The method of claim 1, wherein the available self-service kiosk audibly alerts the nearby customer to the availability by projecting an audio instruction or announcement of availability.

8. The method of claim 1, wherein the plurality of kiosk destinations including a self-return kiosk, a computer terminal operated by an associate, and a pick-up kiosk.

9. A computer system comprising:
a processor;
a memory device coupled to the processor;
a computer readable storage device coupled to the processor, wherein the storage device contains program code executable by the processor via the memory device to implement a method for activating light source hardware to illuminate a guided pathway to a correct kiosk destination that processes self-service orders in a retail location, the method comprising:
receiving, by a processor of a computing system, self-service option information at a self-service kiosk in the retail location, the self-service kiosk having at least one sensor coupled to the processor to detect a presence of a user nearby the self-serving kiosk, wherein the self-service kiosk prompts the user to input information into a graphical user interface of the self-service kiosk regarding a self-service option, in response to the detection of the user;
analyzing, by the computing system, the self-service option information to determine a correct kiosk destination for the user from a plurality of kiosk destinations, based on the self-service option input by the user and received from the self-service kiosk, wherein the self-service order is processed at the correct kiosk destination;
activating, by the processor, at least one lighting element to illuminate the guided pathway to be followed by the user to reach the correct kiosk destination, wherein the guided pathway is visible on a floor of a user queuing location for processing self-service orders, between the self-service kiosk and the correct kiosk destination located in the user queuing location for processing self-service orders of the retail location; and
prompting, by the processor, an available self-service kiosk to audibly or visually alert a nearby customer to an availability of the available self-service kiosk, to reduce a queue of customers in the user queuing location.

10. The computer system of claim 8, wherein the light source is located proximate a ceiling or elevated position with respect to the user, to project the pathway on the floor.

11. The computer system of claim 8, wherein the light source is a plurality of light sources embedded in the floor of the user queuing location.

12. The computer system of claim 8, wherein the available self-service kiosk visually alerts the nearby customer to the availability by flashing a display of the available self-service kiosk.

13. The computer system of claim 8, wherein the available self-service kiosk visually alerts the nearby customer to the availability by activating a light indicator on a front or sides of the available self-service kiosk.

14. The computer system of claim 8, wherein the available self-service kiosk audibly alerts the nearby customer to the availability by projecting an audio instruction or announcement of availability.

15. The computer system of claim 8, wherein the plurality of kiosk destinations including a self-return kiosk, a computer terminal operated by an associate, and a pick-up kiosk.

16. A computer program product, comprising a computer readable hardware storage device storing a computer readable program code, the computer readable program code comprising an algorithm that when executed by a computer processor of a computing system implements a method for activating light source hardware to illuminate a guided pathway to a correct kiosk destination that processes self-service orders in a retail location, comprising:
receiving, by a processor of a computing system, self-service option information at a self-service kiosk in the retail location, the self-service kiosk having at least one sensor coupled to the processor to detect a presence of a user nearby the self-serving kiosk, wherein the self-service kiosk prompts the user to input information into a graphical user interface of the self-service kiosk regarding a self-service option, in response to the detection of the user;
analyzing, by the computing system, the self-service option information to determine a correct kiosk destination for the user from a plurality of kiosk destinations, based on the self-service option input by the user and received from the self-service kiosk, wherein the self-service order is processed at the correct kiosk destination;
activating, by the processor, at least one lighting element to illuminate the guided pathway to be followed by the user to reach the correct kiosk destination, wherein the guided pathway is visible on a floor of a user queuing location for processing self-service orders, between the self-service kiosk and the correct kiosk destination located in the user queuing location for processing self-service orders of the retail location; and
prompting, by the processor, an available self-service kiosk to audibly or visually alert a nearby customer to an availability of the available self-service kiosk, to reduce a queue of customers in the user queuing location.

17. The computer program product of claim 15, wherein the light source is located proximate a ceiling or elevated position with respect to the user, to project the pathway on the floor.

18. The computer program product of claim 15, wherein the light source is a plurality of light sources embedded in the floor of the user queuing location.

19. The computer program product of claim 15, wherein the available self-service kiosk visually alerts the nearby customer to the availability by flashing a display of the available self-service kiosk.

20. The computer program product of claim 15, wherein the available self-service kiosk visually alerts the nearby customer to the availability by activating a light indicator on a front or sides of the available self-service kiosk.
